(19) United States
(12) Patent Application Publication
(10) Pub. No.: US 2010/0281775 A1
(43) Pub. Date: Nov. 11, 2010

(54) System for dehydrating natural gas

(75) Inventor: Allen J. Logue, Barataria, LA (US)

Correspondence Address: KEATY LAW FIRM, LLC, 365 CANAL STREET, Suite 2410, NEW ORLEANS, LA, 70130, US

(73) Assignee: Gly-Tech Services, Inc.

(21) Appl. No.: 12/387,984

(22) Filed: May 11, 2009

(51) Int. Cl. C01B 3/50; B01J 8/00

(52) U.S. Cl. 48/127.3; 48/127.9

(57) ABSTRACT

An apparatus and process for dehydrating a wet natural gas while removing volatile organic compounds (VOC). The well-produced natural gas is contacted with a dehydrating agent, such as glycol, which absorbs water from the natural gas. The mixture of dehydrating agent/water and heavy hydrocarbons is conveyed through a heat exchanger, separator and reboiler for removing VOC and recovering the dehydrating agent for recirculation. A stripping column is coupled to an outlet of the reboiler for stripping the dehydrating agent of any traces of water that is flashed out in the reboiler. Light hydrocarbons removed from the mixture are re-circulated as flash gas in the reboiler, thereby reducing the amount of make-up fuel necessary in the heating process.

### BACKGROUND OF THE INVENTION

The present invention relates generally to an apparatus and process for use with natural gas dehydrators, and more particularly to a system of glycol dehydration of natural gas.

Natural gas used by consumers is composed almost entirely of methane. However, natural gas found at the wellhead, although still composed primarily of methane, is by no means as pure. Gas wells produce raw natural gas by itself, while condensate wells produce free natural gas along with the semi-liquid hydrocarbon condensate. Whatever the source of the natural gas, once separated from crude oil (if present) commonly exists in mixtures with other hydrocarbons, principally ethane, propane, butane, and pentanes. In addition raw natural gas contains water vapor, hydrogen sulfide (H²S), carbon dioxide, helium, nitrogen, and other light and heavy hydrocarbon compounds, as well as various hazardous materials, such as benzene, toluene, ethylbenzene and xylene (BTEX) and other volatile organic compounds (VOCs) that may have carcinogenic components.

Impurities in natural gas, particularly water, can cause many problems in pipeline processing equipment. For this reason, it has been a common practice to treat the natural gas at the wellhead to remove these impurities. Removing water molecules and other hydrocarbons helps to prevent clogging of the pipeline with liquid water or hydrocarbons, and also helps prevent corrosion of the pipelines.

The most commonly used method of removing water from the natural gas is through glycol dehydration. Removing the water in the glycol specifically entails heating the glycol to between 350 and 400° F. at atmospheric pressure. This vaporizes the water to leave a pure stream of glycol.

The, other hydrocarbon impurities, BTEX compounds, are also removed by simply heating the glycol in a traditional atmospheric pressure reboiler, which also vaporizes those hydrocarbons that are then released into the atmosphere. This presents an environmental problem. The EPA estimates that there are approximately 40,000 glycol dehydration units in this country that account for about 88% of the total BTEX emissions for the oil and gas industry. The control of BTEX emissions is one of the largest environmental challenges facing the U.S. natural gas industry.

Conventional natural gas processing consists of separating all of the various hydrocarbons impurities from the pure natural gas, to produce what is known as “pipeline quality” dry natural gas, or product natural gas. Major transportation pipelines usually impose restrictions on the makeup of the natural gas that is allowed into the pipeline grid. That means that before the natural gas can, be transported, it must be purified.

While the ethane, propane, butane, and pentanes may be removed from natural gas, this does not mean that they are all “waste products.” In fact, associated hydrocarbons, known as “natural gas liquids” (NGLs) can be a very valuable by-product of natural gas processing. NGL's include ethane, propane, butane, iso-butane, and natural gasoline. The NGLs can be sold separately and have a variety of different uses, including enhancing oil recovery in oil wells, providing raw materials for oil refineries or petrochemical plants, and as sources of energy.

The gas industry employs a variety of equipment for processing well-generated components. One such type of equipment is oil and water separator, which is most often used to produce high-pressure gas along with crude oil or condensate. It is recognized that in addition to separating oil and some condensed gas stream, it is necessary to remove most of the associated water. Most of the liquid water associated with the extracted natural gas can be removed by a simple separation method at or near the wellhead. However, the removal of water vapor that exists in solutions in natural gas process requires a more complex treatment. This treatment consists of “dehydrating” natural gas, which usually involves one of two processes: either absorption or adsorption. Absorption occurs when the water vapor is taken out by dehydrating agents. Adsorption occurs when the water vapor is condensed and collected on the surface.

An example of absorption dehydration is known as glycol dehydration. In this process, a liquid desiccant (dehydrating agent) serves to absorb water vapor from the gas stream. Glycol, the principle agent in this process has a chemical affinity for water. This means that, when in contact with a stream of natural gas that contains water, glycol will serve to ‘steal’ the water out of the gas stream. Essentially, glycol dehydration involves using a glycol solution, usually either diethylene glycol (DEG) or triethylene glycol (TEG), which is brought into contact with the wet gas stream in a tower often referred to as “contactor.”

The typical natural gas glycol dehydration process transfers water from the gas to a liquid stream of glycol and simultaneously removes a small portion of the BTEX and other volatile organic compounds. During the regeneration of the glycol, the water (in the form of steam) and the absorbed hydrocarbons are emitted to the atmosphere or further processed through an emissions control technology.

Some conventional dehydration units use a vapor recovery system (VRS) to control emissions, while others utilize incineration systems to destroy all organic components vented from a glycol purifier. Typical VRS systems employ condensation of water and heavy hydrocarbons using either air, or water, or glycol as the cooling agent, followed by three-phase separation. Most of the systems employ an atmospheric reboiler, where the pressure within the system is reduced to atmospheric pressure and the rich glycol is heated to about 350-400° F. The resulting gas is condensed to remove the water and BTEX. The products of separation are condensable hydrocarbons, water in its liquid form, and non-condensable gases. Because separation occurs at atmospheric pressure, all three phases must be pumped or compressed to storage tanks and the gas system. The incineration systems have high operating costs and do not recover any hydrocarbons for sales.

Other methods of gas dehydration and BTEX separation employ a stripping gas with gas bubble-caps located within a stripper vessel under pressure. Problems with this system include the initial cost of the complex array of bubble caps themselves, the inability of the system to recover and thus use the BTEX and other components that are carried off by the stripping gas, and the stripping gas required is often more than can be used as fuel, the excess being flared which adds to waste of material.

There exists therefore a need for an improved system and method of natural gas dehydration and removal of hazardous components while using glycol as a water absorption medium.

### SUMMARY OF THE INVENTION

It is, therefore, an object of the present invention to provide a system of natural gas dehydration.

It is another object of the invention to provide a method of natural gas dehydration using strip burning.

It is a further object of the invention to provide an apparatus and method of natural gas dehydration that employ glycol for water absorption.

It is still a further object of the invention to provide a system of natural gas dehydration that allows an operator to reduce costs associated with the natural gas processing.

These and other objects of the invention are achieved through a provision of an apparatus and process for dehydrating a wet natural gas while removing volatile organic compounds (VOCs). The well-produced wet natural gas is contacted with a dehydrating agent, such as glycol, which absorbs water from the natural gas. The mixture of dehydrating agent/water and heavy hydrocarbons is conveyed through a heat exchanger, separator and reboiler for removing VOCs and recovering the dehydrating agent for recirculation. A stripping column is coupled to an outlet of the reboiler for stripping the dehydrating agent of any traces of water that is flashed out in the reboiler. Light hydrocarbons removed from the mixture are re-circulated as flash gas in the reboiler, thereby reducing the amount of make-up fuel necessary in the heating process.

### BRIEF DESCRIPTION OF THE DRAWINGS

Reference will now be made to the drawings, wherein like parts are designated by like numerals, and wherein

FIG. 1 is a schematic view of the gas dehydration system of the present invention.

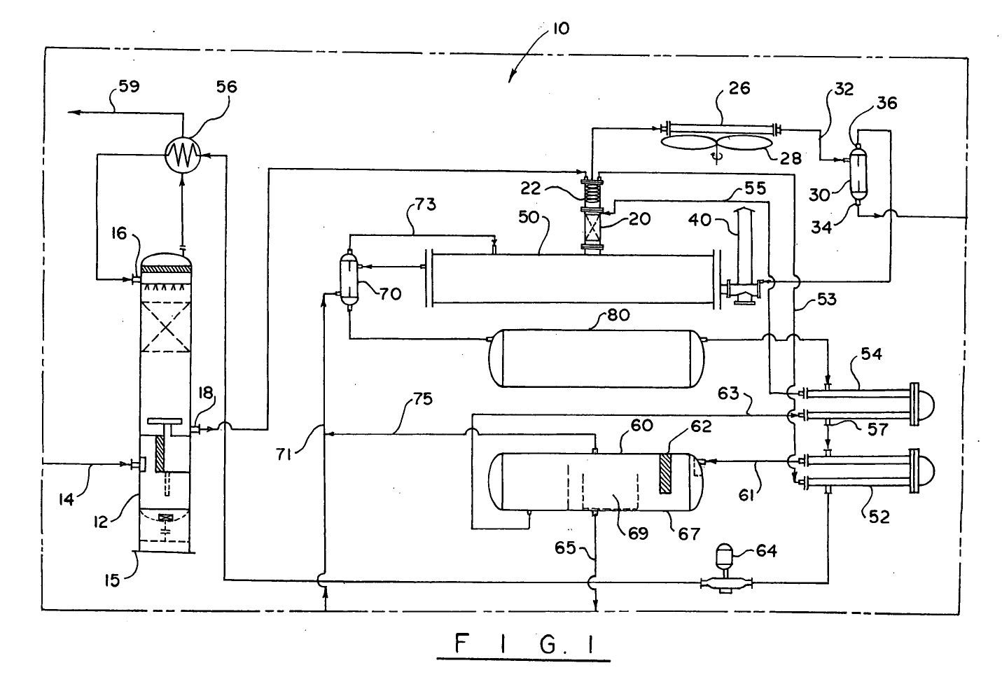

### DETAIL DESCRIPTION OF THE INVENTION

Turning now to the drawing in more detail, numeral 10 designates the system of natural gas dehydration according to this invention. The system 10 comprises a contactor 12, which receives wet natural gas from a ground well (not shown) through a suitable conduit 14. The contactor 12 has a multistage-type design. If necessary, the contact tower 12 can be mounted on a skid 15 to facilitate transportation of the contact tower to an in-situ location.

In the illustrated embodiment, the wet natural gas is introduced into the contactor 12 at a lower location and flowed up through the contactor 12 against an oppositely traveling dehydrating agent, such as glycol, which has been introduced at an upper location of the contactor 12 through an inlet 16. At this stage, the wet natural gas is pressurized to the pressure of the ground well, arriving in the contactor 12, for the purpose of this description, at 900-1000 p.s.i and temperature of about 100° F. This invention works well with other manifestations of pressure and temperature of the wet gas arriving at the contactor 12, in both higher and lower values.

As a result of physical contact between the oppositely traveling fluids, associated components within the gas stream are absorbed into the glycol compound. What was originally “lean” or “clean” glycol is subsequently laden with these components having an affinity therefor. Among others, those components include hydrocarbons, or VOCs that include organic compounds that are heavier than “sweet” natural gas with examples being ethane, propane, butane, benzene, toluene, and xylene. When laden with these compounds, the hydrocarbon/glycol solution can be regenerated by removing these VOCs and then being re-circulated back to the contact tower 12. Two streams are created in the contact tower 12: the first stream is dry natural gas that can be removed and sold to utilities as product natural gas, and a second stream containing glycol/water mixture and hydrocarbon-containing compounds associated with the natural gas.

The glycol solution absorbs water from the wet gas. During the absorption process, the glycol movement from the top of the contactor 12 to the bottom of the vessel is gravity induced. The wet hydrocarbon laden second stream is evacuated from the contactor 12 via an outlet 18. The second stream containing hydrocarbons, water and glycol is transported to a distillation column 20, which is provided with a reflux condenser 22, with a reflux coil 24 on top thereof. The distillation column 20 is adapted for distilling the glycol/water mixture, while separating hydrocarbons and water vapor.

The reflux coil 24 maintains a temperature atop of the distillation column 20. In the preferred embodiment, the reflux condenser 22 maintains the temperature of the solution at about 215° F. and at pressure of about 7.5 p.s.i. The natural gas, having been stripped of most of its water content, is then transported out of the distillation column 20. While water has a boiling point of 212° F., glycol can be heated to 400° F. Before thermal decomposition of the glycol begins, this temperature differential allows to remove water from the glycol solution, while recovering glycol for use in the dehydration process.

Some of the water and hydrocarbons can be removed directly from the distillation column 20 and transferred to a cooling condenser 26, where a fan 28 cools the heated water vapor. The water-hydrocarbon solution is transferred to a sump trap 30. The sump trap 30 produces the same effect as the condensate knockout tank by providing a low point collection for condensate that forms in the conduit lines 32 and a reservoir which slows the gas velocity and allows additional gas-water separation. Separated water is removed from the sump trap via outlet 34, while released hydrocarbon gases are transferred via a sump trap outlet 36 to a burner 40.

The glycol/water solution, second stream, used as the cooling medium in the reflux coil 22 atop the distillation column 20 is then transported. The reboiler 50 is adapted for heating glycol/water mixture to vaporize water. The heat exchanger assembly comprises a first (cooling) heat exchanger 52, which raises the temperature of the glycol-water solution transported from the distillation column 20 by a conduit 53.

The outlet of the first heat exchanger 52 is connected to an inlet of a flash tank, or separator 60. Essentially, a flash tank separator 60 consists of a device that reduces the pressure of the glycol solution stream, allowing the methane and other hydrocarbons to vaporize (‘flash’). The glycol solution then travels to the second heat exchanger then to the reboiler 50, which may also be fitted with air or water-cooled condensers, which serve to capture any remaining organic compounds that may remain in the glycol solution. The specialized reboiler 50 is designed to vaporize only the water out of the glycol-hydrocarbon gas solution.

The separator 60 is provided with a mist extractor 62 adjacent an inlet end 67, where a mixture of glycol, water and hydrocarbon gas enters the separator from the cold heat exchanger 52. The temperature of the mixture is increased to about 150° F. while the pressure is held to about 50 p.s.i. The glycol and water proceed at the end of the separator vessel 60 into a retention channel where liquid hydrocarbons are skimmed an inside container 69, from which liquid hydrocarbons are removed through a conduit 65.

Wet hydrocarbon-containing gases exit the separator vessel 60 via a conduit 75, which is operationally connected with the stripping column 70. The flash gas, which contains lighter fraction of the hydrocarbon-containing compounds and which becomes separated from the glycol/condensate/gas mixture in the separator 60 is not wasted, but instead is used as a primary fuel in the reboiler 50.

After passing through the mist extractor 62 and below the inside container 69, the remaining glycol with captured water are transported to the second heat exchanger 54 through the conduit 63, where these substances are warmed to about 300° F.

From the hot heat exchanger 54, hot glycol and residual water enter the distillation column 20, where the wet glycol stream allows the water and hydrocarbon vapors containing hydrocarbons, glycol and water to flash.

A conduit 61 carries a stream of glycol, water and hydrocarbons from the first heat exchanger 52 to the flash tank 60. The first heat exchanger 52 is also fluidly connected to an outlet 57 of a second (heating) heat exchanger 54, receiving glycol, reconcentrated at about 250° F. and pressure of about 2.5 p.s.i.

Another outlet of the hot heat exchanger 54 is fluidly connected to the distillation column 20 via a conduit 55. The second heat exchanger 54 heats the residual glycol and water stream to about 300° F. and pressure of about 5 p.s.i. before delivering the glycol/water solution to the distillation column 20. The second heat exchanger 54 receives glycol and water mixture from the separator 60 via a conduit 63.

Lean glycol, stripped of any traces of water and hydrocarbons is received from the cold heat exchanger 52 by a pump 64 at temperature of about 110° F. and pressure of about 1 p.s.i. The pump 64 is operationally connected to a third, gas-glycol heat exchanger 56 coupled to the top of the contact tower 12. The third heat exchanger 56 receives lean glycol from the pump at contactor pressure for recirculation in the contact tower 12 and for absorption of water from a new batch of natural gas entering the contact tower 12. Dry sweet natural gas, suitable for sale to utility customers as product natural gas leaves the third heat exchanger 56 via a conduit 59.

The system of the present invention further comprises a stripping column 70 mounted between the flash tank separator 60 and the reboiler 50. The glycol and remaining water enter the stripping column 70 from the reboiler 50. The flash gas that is released to the separator 60 also goes to the stripping column 70. The stripping column 70 is configured to have a counter current flow—the glycol and captured water entering the top and hydrocarbon gas from an outside source entering the bottom. The make up gas is delivered to the stripping column 70 through a conduit 71, mixed with the hydrocarbon gases that exit the separator vessel 60.

As the glycol-water mixture passes through the gas stream, the gas is taking the traces of water that are still in the glycol before it enters surge tank 80. This gas stream takes the small traces of water that are very valuable to purifying the glycol and takes it through the distillation column 20 with the remaining water that was released from glycol. Water, glycol and hydrocarbon vapor passing through distillation column 20 proceeds into a condenser 22 that cools the stream to a temperature of about 215° F. where glycol vapor is condensed for recovery in reboiler 50. The remaining water, hydrocarbon vapor passes through condenser 26. Condensed water and hydrocarbons are collected by sump 30 and evacuated. Non-condensable hydrocarbons and water vapor passes from sump 30 through conduit 36 and then is used as primary fuel in the reboiler 50.

As lean glycol exits the stripping column 70, it travels to a surge tank 80 mounted between the stripping column 70 and the second heat exchanger 54. The surge tank 80 generally maintains the temperature of lean glycol at about 400° F. and pressure of about 5 p.s.i. The glycol from the hot heat exchanger 54 travels to the cold heat exchanger 52 and then is used by the pump 64 to increase the pressure from about 1 p.s.i. to the contact tower pressure of 1000 p.s.i.

In operation, lean glycol without water enters the top of the contact tower 12. Lean glycol has been pumped up to the high-pressure using the pump 64. The temperature in the contact tower 12 for purposes of this example is maintained at about 100° F. and pressure is maintained at about 1000 p.s.i. As glycol exits the contact tower 12, it carries with it hydrocarbons and water. The mixture of glycol, hydrocarbons and water proceeds to a reflux coil 24 of the reflux condenser 22, which is maintaining a temperature atop of the distillation column 20 of about 215° F.

The mixture then proceeds to the first heat exchanger 52 where it takes heat from the warm glycol as it exits the reboiler 50 and raises the temperature of the rich glycol that has the hydrocarbon and the water from 100° F. to 150° F. The warm rich glycol enters the flash tank, or the gas-condensate-glycol separator 60. This allows for resonance time which enables the condensate liquids to separate from the glycol and water and it also operates at 50 p.s.i., which is considerably less than the absorber or the contact tower pressure. As a result, the hydrocarbons exit glycol as liquid hydrocarbons as well as a flash gas.

The glycol and water proceed at the end of the separator vessel 60 after passing through the mist extractor 62, and beneath container 69 to go through another heat exchange in the second heat exchanger 54 warmed again by hot glycol that is exiting the reboiler 50 from 150° F. to 300° F. Then, a mixture of glycol and water enters the distillation column 20, which is open to the reboiler 50. The water/glycol mixture is transferred to the reboiler 50, which is heated by the furnace 40.

Water vapor goes up the distillation stack 20. Exhaust of the furnace 40 is open to the atmosphere. The reboiler heats the glycol/water mixture to about 400° F., while maintaining the pressure at about 7.5 p.s.i. The water in the glycol/water mixture is stripped out by boiling and flashing at a lower pressure in the reboiler 50. The stripping column 70, which receives the glycol and residual water mixture, strips glycol of any remaining traces of water and hydrocarbons to produce lean glycol, which if transferred at the same pressure and temperature to the surge tank and then to the second heat exchanger 54. The water vapor and remaining hydrocarbon gases are returned from the stripping column 70 through the conduit 73, to the reboiler 50 for further processing.

The system and method of the instant invention provide various advantages in comparison with conventional glycol reconcentration systems. One of the advantages is that it reduces costs associated with operating the unit. The primary cost of these units is the gas that it takes to burn in the fire tube of the reboiler. By utilizing exhaust gases that come from the flash separator 60, the user can reduce the amount of makeup gas that is being delivered from the outside source by the conduit 71.

Additionally, the system uses all the gas in a stripping fashion, while making the glycol extremely lean of water. In effect, the flash gas is used to strip the maximum amount of water from glycol. This method is assisted through the regulating of pressure between a relatively high pressure in the separator (about 50 p.s.i.) and the stripping column (about 7.5 p.s.i.). During this step, relatively dry hydrocarbon gas is pushed through the glycol, absorbing more water out of the glycol stream. The water is then flashed off. In the distillation column, the water content of the glycol is reduced before it enters the reboiler 50.

The method provides for a combination of the stripping and the distillation steps. The stripping with the low pressure/high temperature gas and the distillation of the same gas stream allows the user to carry over the water, remove glycol and then as the gas and water go overhead, they are cooled immediately with a fan cooler, or overhead vapor condenser 26 having a fan condensate cooler 28. Additionally, the sump tank 30 separates out the water and the gas. The gas is then burned in the burner 40.

As a consequence, it takes less glycol circulated to remove the water in the contact tower 12. Therefore, the circulation rate necessary for the contacting is reduced, and the amount of heat loss that is lost through the system as it operates is reduced. As a result, less fuel is required in the reboiler to increase the vat temperature. The combustion temperature of the fire tube is great enough to bring carbon monoxide levels down to below 10 parts per million and that essentially proves that VOCs are completely removed. The burner is burning at 1600° F., which is the combustion temperature. Because of the high temperature, all VOCs present in the crude natural gas burn out and exit out the stack, or burner 40.

The instant method provides for the beneficial use of hydrocarbon gases, which are used for stripping to provide leaner glycol. The instant method allows to use a stripping column to produce lean glycol and take extra water out with make up and flash gas. An additional benefit is that instead of using the flash gas as a flare or thermal oxidizer with wasted heat to the environment, the instant system uses it as a primary fuel in the reboiler.

Many changes and modifications can be made in the system and method of the present invention without departing from the spirit thereof. I therefore, pray that my rights to the present invention be limited only by the scope of the appended claims.

I claim:

1. A method of dehydrating a wet natural gas containing hydrocarbon compounds produced from a well, comprising the steps of:
a) providing an apparatus for dehydrating the natural gas comprising a contact tower, a distillation column, a separator, a reboiler, a stripping column, and a heat exchanger assembly;
b) feeding said wet natural gas containing hydrocarbon compounds to a contact tower;
c) feeding a dehydrating agent to said contact tower and permitting said dehydrating agent to associate with said wet natural gas containing hydrocarbon compounds within said contact tower;
d) causing said dehydrating agent to dehydrate said wet natural gas to produce a first stream composed of dry natural gas and a second stream composed of dehydrating agent/water mixture and hydrocarbon containing compounds;
e) feeding said second stream from said contact tower to said distillation column, while maintaining temperature in said distillation column at or at least slightly above a water boiling point, thereby causing separation of water vapor and light hydrocarbon fractions from said second stream;
f) feeding said second stream through a first member of the heat exchanger assembly, while heating said second stream;
g) transporting said second stream through the separator, while causing liquid hydrocarbon compounds to separate from the second stream;
h) recovering from the second stream, remaining light fractions of hydrocarbon-containing compounds as flash gas;
i) causing separated dehydrating agent/water mixture to pass through a second member of the heat exchanger assembly;
j) delivering the heated dehydrating agent/water mixture to a reboiler and heating the dehydrating agent/water mixture to a degree sufficient to vaporize water, while recovering the dehydrating agent;
k) transferring the recovered dehydrating agent with traces of water to the stripping column and recovering lean dry dehydrating agent.

2. The method of claim 1, further comprising the step of re-circulating the flash gas recovered in step (h) as a fuel source for step (k).

3. The method of claim 1, further comprising a step of removing the first stream from said contact tower as product natural gas.

4. The method of claim 1, further comprising a step of providing a reflux condenser and operationally connecting the reflux condenser to the distillation column.

5. The method of claim 4, wherein said heat exchanger assembly comprises a first member mounted between the reflux condenser and the separator, a second member mounted between the separator and the distillation column, and a third member mounted between the first member and the contact tower.

6. The method of claim 5, further comprising a step of providing a pump between the first member of the heat exchanger assembly and the third member of the heat exchanger assembly.

7. The method of claim 6, further comprising a step of transferring under pressure a lean dehydrating agent from said first member of the heat exchanger assembly to said third member of the heat exchanger assembly for re-circulation in said contact tower.

8. The method of claim 5, further comprising a step of providing a surge tank mounted between the stripping column and the second member of the heat exchanger assembly.

9. The method of claim 1, further comprising a step of providing a sump tank, said sump tank receiving influx of water vapor and light hydrocarbon fractions generated in step (e).

10. The method of claim 9, further comprising a step of removing water from a bottom of said sump tank, while conveying the light hydrocarbon fractions for burning in the reboiler.

11. The method of claim 1, further comprising a step of removing liquid hydrocarbon-containing compounds from the separator.

12. The method of claim 1, wherein the first stream and the second stream are produced in the contact tower normally at a temperature of about 100° F. and pressure of about 1000 p.s.i.

13. The method of claim 12, wherein said reflux condenser is adapted for reducing temperature of the second stream to about 215° F. and pressure of about 7.5 p.s.i.

14. The method of claim 1, wherein said separator is adapted for separating the dehydrating agent/water mixture at a temperature of about 150° F. and pressure of about 50 p.s.i

15. The method of claim 1, wherein the reboiler and the stripping tower are each adapted to maintaining temperature of processing at about 400° F. and pressure at about 7.5 p.s.i.

16. An apparatus for separating a wet natural gas containing hydrocarbon compounds produced from a well, comprising:
a contact tower configured for receiving the wet natural gas in a lower portion thereof and for receiving a dehydrating agent in an upper portion thereof;
a heat exchanger assembly mounted in operational relationship to said contact tower;
a reboiler configured for heating the wet natural gas and the dehydrating agent to a temperature sufficient to cause separation of water from the natural gas;
a stripping tower coupled to an outlet said reboiler, said stripping tower being adapted for removing traces of water from the dehydrating agent;
a distillation column mounted downstream from said contact tower and configured for receiving influx of natural gas/dehydrating agent and hydrocarbon-containing compounds mixture from the contact tower; and
a separator mounted downstream from said distillation column, said separator being configured for separating liquid and light hydrocarbon-containing compounds from the dehydrating agent/water mixture.

17. The apparatus of claim 16, further comprising an overhead vapor condenser coupled to said distillation column downstream of the reflux condenser.

18. The apparatus of claim 17, further comprising a sump tank mounted downstream from said overhead vapor condenser, said sump tank being configured for removing water from a stream of hydrocarbon-containing compounds released from the overhead vapor condenser, while recovering hydrocarbon-containing compounds for transfer to the reboiler.

19. The apparatus of claim 16, wherein said heat exchanger assembly comprises a first member mounted between the reflux condenser and the separator, a second member mounted between the separator and the distillation column, and a third member mounted between the first member and the contact tower.

20. The apparatus of claim 19, further comprising a pump mounted between the first member of the heat exchanger assembly and the contact tower, said pump being configured for delivering under pressure of lean dry dehydrating agent for re-circulation in the contact tower.

21. The apparatus of claim 19, further comprising a surge tank mounted between the stripping column and the second member of the heat exchanger assembly.
